(19) United States
(12) Patent Application Publication
(10) Pub. No.: US 2006/0082815 A1
(43) Pub. Date: Apr. 20, 2006

(54) Transceiver controlling a plurality of antennas for communication with wireless memory devices in a printing system

(76) Inventor: Ray Allen Walker, Eugene, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/966,316

(22) Filed: Oct. 14, 2004

(51) Int. Cl. G06F 3/12; G06F 15/00; G06K 1/00

(52) U.S. Cl. 358/1.15

(57) ABSTRACT

Disclosed are transceivers for communicating with wireless memory devices integral with replaceable printing components, the transceivers configured to separately access multiple antennas for selectively communicating with a plurality of memory devices. Also disclosed are printing systems incorporating such transceivers.

### FIELD OF INVENTION

This invention relates generally to printing systems having user-replaceable printing components, such as containers for marking material, and more particularly to printing systems with replaceable components having integral wireless electronic memory devices.

### BACKGROUND OF THE INVENTION

Printing systems utilizing user-replaceable components, including inkjet printers with replaceable ink containers and laser printers with replaceable toner cartridges, are well-known in the art. In inkjet printing systems, an inkjet printhead is typically mounted on a carriage that is moved back and forth across a print media, such as paper. As the printhead is moved across the print media, a control system activates the printhead to deposit or eject ink droplets onto the print media to form text and images. Ink is provided to the printhead from a supply of ink that is either carried by the carriage or mounted to a fixed receiving station (commonly referred to as “off-axis”). When the ink supply is not carried with the carriage, the ink supply can be intermittently or continuously connected to the printhead for replenishment. In either case, the ink containers require periodic replacement when the ink is exhausted. Other printing components, such as the printheads, may also replaceable by the user when they reach the end of their useful life.

In electrophotographic or “laser” printing systems, the replaceable consumable is typically the electrophotographic engine frequently referred to as a toner cartridge. The toner cartridge often includes an intermediate imaging device such as a drum, and a reservoir of imaging material such as powdered toner. The drum is charged using an energy source such as a scanning laser. The imaging material is attracted to the charged drum and is then transferred to print media.

Regardless of the type of printing system, it is now common for replaceable printing consumables to include integral electronic memory devices. The memory devices may be used as “keying” features to differentiate between dissimilar consumable substances (such as, for example, to distinguish between colors); may contain calibration information; or may be used to indicate a status condition of the replaceable component, such as the substance level within a consumable container. The memory devices may also be used for many other purposes, such as enabling specialized features of the printing system, tracking the replaceable printing components in manufacturing, distribution or recycling channels, or providing other value to the system user.

It can also be desirable to alter printer parameters or provide information to the printer concurrently with the replacement of the replaceable printing components, such as discussed in U.S. Pat. No. 5,699,091 entitled “Replaceable Part With Integral Memory For Usage, Calibration And Other Data,” assigned to the assignee of the present invention. U.S. Pat. No. 5,699,091 discloses the use of a memory device that contains parameters relating to the replaceable printing component. The installation of the replaceable printing component allows the printer to access the replaceable part parameters to insure high print quality. By incorporating the memory device into the replaceable printing component and storing replaceable part parameters in the memory device within the replaceable component, the printing system can determine these parameters upon installation into the printing system. This automatic updating of printer parameters frees the user from having to manually update printer parameters each time a replaceable component is newly installed. Automatically updating printer parameters with information from the replaceable printing components can help insure high print quality. In addition, automatically updating the parameters can ensure that the printer is not inadvertently damaged due to improper operation, such as, for example, operating after the supply of ink; is exhausted or using incompatible components.

Regardless of particular use made of the stored information, it is important that the exchange of information between the printer and the replaceable printing component be accomplished in a highly reliable manner. Recently, wireless memory devices (such as described in U.S. Pat. No. 6,312,106, “Method and apparatus for transferring information between a replaceable consumable and a printing device,” assigned to the assignee of the present invention) have become an attractive alternative to memory devices having physical electrical contacts.

Several factors have made wireless memory devices an attractive alternative to the more conventional “wired” devices. Electrical contacts or terminals positioned on the outer portion of the replaceable printing component are subject to corrosion and mechanical damage such as scraping, denting or pealing, which may result in reliability problems or failures of the electrical interconnect between the printer and the replaceable consumable. Exposed contacts can lead to open or short circuits resulting, for example, from ink spills within the printer. Exposed electrical contacts also potentially subject the memory or storage device to electrostatic discharge (ESD), which can result in catastrophic failure or reduced lifetime of the storage device.

With the continuing evolution of IC technology, it has recently become possible to integrate the non-volatile memory, control electronics, and a receive/transmit antenna into a single low-cost device. The physical simplicity of the single integrated device can lower the total cost of a printer consumable when compared to the use of memory devices with wired connections. In manufacturing and distribution, it can also be more efficient to initialize the wireless memory devices, since there is no need to form electrical connections with each device independently.

The use of wireless devices, however, introduces several design considerations not present with physical interconnects, such as the need to insure compliance with regulatory agency requirements for wireless transmissions, the need to insure that adequate power is transmitted to each device, and the potential for interference or crosstalk between devices. These considerations are of increased significance when a printer includes multiple user-replaceable components.

A trend in printing systems is the increasing use of separate user-replaceable containers for each consumable substance, such as separate containers for each ink color or overcoating fluid. Separate containers are perceived as being more cost-effective by users, since the entire contents of the container can be utilized before the container is replaced, unlike combined containers, where, for example, substantial amounts of cyan and magenta ink may be discarded when the yellow ink is depleted. A further trend is the use of a greater number of different ink colors to better reproduce the full gamut of photographic images, such as the addition of “light” cyan, “light” magenta, or shades of gray. A printing system may thus commonly accommodate six or more separate ink containers, each of which may have an integral memory component with which the printing system must communicate.

There is thus a need for apparatus and methods that provide for reliable and cost-effective communication between a printing system and the integral wireless memory devices of replaceable printing components.

### SUMMARY OF THE INVENTION

Embodiments of the present invention include transceivers for communicating with wireless memory devices integral with replaceable printing components, the transceivers configured to separately access multiple antennas for selectively communicating with a plurality of memory devices. Further embodiments include printing systems having such transceivers.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates an exemplary printer having replaceable printing components, such as may incorporate embodiments of the invention;

FIG. 2 schematically illustrates how a replaceable printing component may be positioned within a printing system to best facilitate communication between the printing system and a wireless memory device integral with a replaceable printing component, in accordance with embodiments of the invention;

FIG. 3 illustrates an exemplary wireless memory device that may be used with embodiments of the invention;

FIG. 4 is an electrical block diagram illustrating the operation of an exemplary wireless memory device;

FIG. 5 illustrates a “prior art” printing system utilizing memory devices having physical electrical connections;

FIG. 6 illustrates an exemplary printing system with multiple replaceable printing components having integral wireless memory devices, the memory devices accessed utilizing a single antenna;

FIG. 7 illustrates an alternative printing system with multiple replaceable printing components having integral wireless memory devices, and separate RF transceivers and antennas for accessing each replaceable printing component memory device;

FIG. 8 illustrates an exemplary printing system according to an embodiment of the invention, the printing system having a single RF transceiver which separately selects one of two antennas for communication with different groups of replaceable printing component memory devices;

FIG. 9 illustrates a generalized exemplary printing system according to an embodiment of the invention, the printing system having a single RF transceiver which separately selects one of “N” antennas for communication with one of “N” replaceable printing component memory devices; and

FIG. 10 illustrates a further embodiment of an exemplary printing system, having multiple RF transceivers each addressing a plurality of replaceable printing component memory devices.

### DESCRIPTION OF EMBODIMENTS OF THE INVENTION

Embodiments of the invention are described with respect to an exemplary inkjet printing system; however, the invention is not limited to the exemplary system, nor to the field of inkjet printing, but may be utilized in other systems.

In the following specification, for purposes of explanation, specific details are set forth in order to provide an understanding of the present invention. It will be apparent to one skilled in the art, however, that the present invention may be practiced without these specific details. Reference in the specification to “one embodiment” or “an exemplary embodiment” means that a particular feature, structure, or characteristic described in connection with the embodiment is included in at least one embodiment. The appearance of the phrase “in one embodiment” in various places in the specification do not necessarily refer to the same embodiment.

FIG. 1 illustrates an exemplary printing system 10 in which embodiments of the invention may be incorporated. The exemplary inkjet printing system includes a stationary portion 30 and a scanning carriage 20; the scanning carriage is typically scanned across print media while ink is deposited on the media. The printing system typically includes other mechanisms and components not shown in FIG. 1, such as mechanisms for media handling and user interfaces, as well-known in the art. In the exemplary embodiment of FIG. 1, the scanning carriage may also serve as a consumable receiving station, into which multiple replaceable printing components 100a, 100b, 100c, 100d, (in this case print cartridges) are docked. In other printing systems, the consumable receiving station may by located on the stationary portion 30 of the printing system, in which case the consumables are typically ink containers that provide ink to separate on-carriage printheads through an ink delivery system (not shown). For illustrative purposes, four replaceable printing components are shown; the number may of course vary with differently configured printing systems, and may consist of ink containers, printheads, or print cartridges incorporating both ink supplies and printheads.

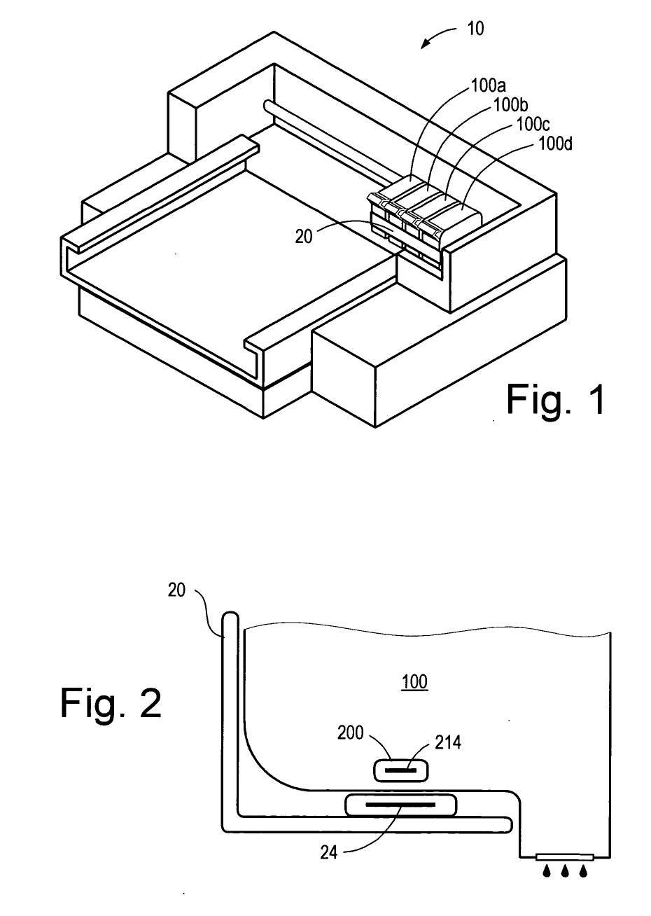

FIG. 2 illustrates in schematic form how an integral wireless memory device 200 of a replaceable printing component 100 is typically placed in close proximity to an antenna coil 24 of the printing system to enable communication between the system and the memory device. Exemplary replaceable printing component 100 is shown for illustrative purposes as an ink cartridge having an inkjet printhead; the cartridge is shown mounted on scanning carriage 20. As shown in FIG. 2, the antenna coil 24 of the system and the antenna coil 214 of the wireless memory device 200 are in close physical proximity with the planes of the two antennas substantially parallel (shown in side view in FIG. 2). Electrical communication between the printer system and memory device may typically utilize communication technology and protocols commonly referred to as Radio Frequency Identification (RFID); the physical transmission mechanism could be characterized as inductive coupling of the two coils 24, 214.

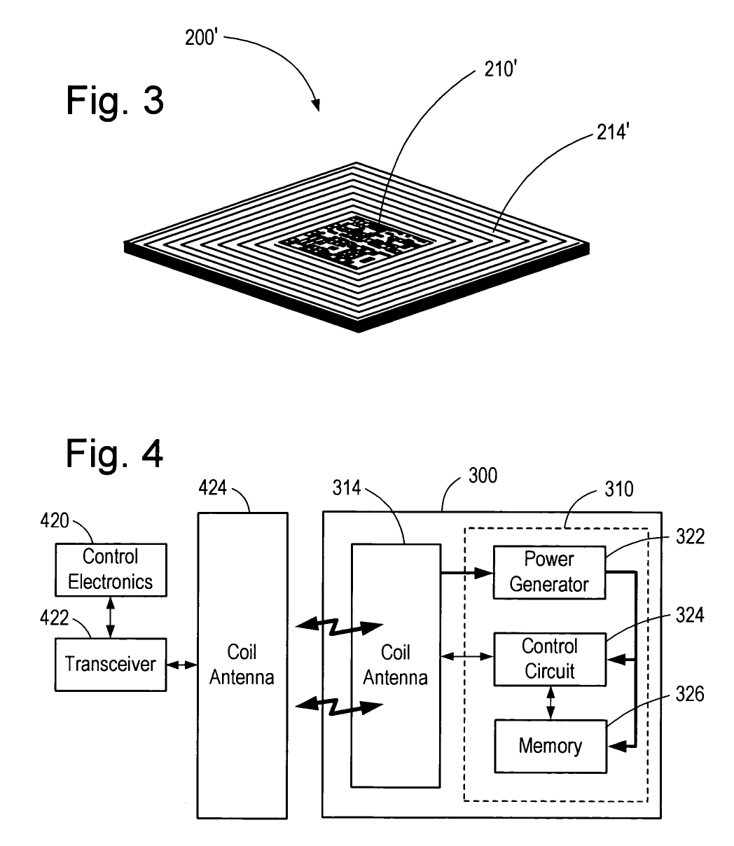

FIG. 3 illustrates one exemplary wireless memory device 200′. An exemplary technology for implementing the memory device is COIL-ON-CHIP™ technology developed by Hitachi Maxell. The exemplary memory device includes an antenna coil 214′ mounted on a 2.5 mm square integrated circuit chip; the antenna surrounds electronic circuitry 210′ providing power generation, control circuitry, and memory, as described below. With the antenna coil formed on the chip surface, the exemplary electronic memory device 200′ is a complete module, requiring no additional electrical components or interconnections.

The exemplary memory device 200′ is a Read/Write device with 128 bytes total memory which can be written to or read using various RFID reader methods known in the art. Typically, a reader/writer (not shown in FIG. 3) is placed adjacent to the item containing the memory device, with the antenna of the reader/writer parallel to the coil antenna 214 of the memory device. The memory device derives both electrical power and data from the RF field generated by the reader/writer. The exemplary memory device typically operates with a carrier frequency of 13.56 MHz; an operating distance of approximately 0.5 mm to 3 mm (variable depending on the performance of the Reader/Writer or system environment); and a data rate of 26.48 thousand bits-per-second (kbps). The memory of the exemplary device is configured as Electrically Erasable Programmable Read-Only-Memory (EEPROM), although other configurations of memory may be utilized, such as, for example, Read-Only-Memory (ROM) or Programmable Read-Only-Memory (PROM).

Other suitable technologies may also be used, including technologies in which the electronic circuitry and antenna are independent devices on a common substrate, and technologies utilizing a discrete antenna element.

FIG. 4 is an electrical block diagram illustrating the operation of the exemplary memory device. Contained on the integrated circuit 300 are a coil antenna 314 and the electronic circuitry 310. The electronic circuitry includes a power generation circuit 322 to derive electrical power for the electronic circuitry from the RF field impinging on the antenna; EEPROM 326; and control circuitry 324 to control reading and writing from the EEPROM 326 and to receive data from, and send data to, the antenna. In operation, control electronics 420 in the printing system (or in a separate programming or reading station, not shown) generate signals to control a transceiver 422 attached to an antenna 424, which generates an RF field that allows reading and writing of data from the memory device 300 by the control electronics.

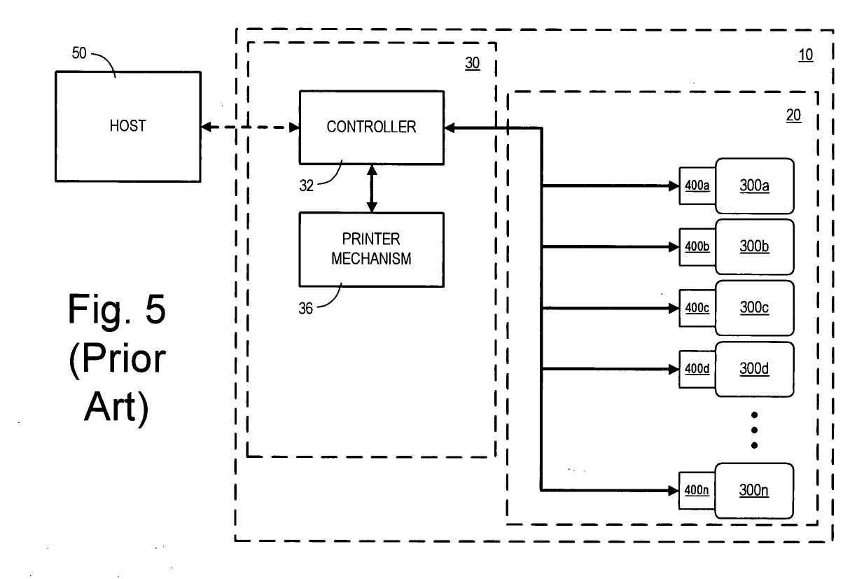

When utilized in a printing system, memory devices on printing consumables are typically in electrical communication with a controller within the printing system. FIG. 5 illustrates an exemplary “prior art” printer system 10 using conventional wired memory devices. A controller 32, typically located in the chassis 30 of the printing system, monitors and controls the printing mechanism 36 of the printer and communicates with the memory devices 400a-400n on the replaceable printing components 300a-300f, which may be located on the scanning carriage 20. The controller may also communicate with a host 50, such as a computer system. The conventional wired memory devices 400a-400n may be serial input/output devices, typically with 4-pin electrical contacts, with each memory device requiring a mechanical connector to establish the physical electrical interface to the printing platform.

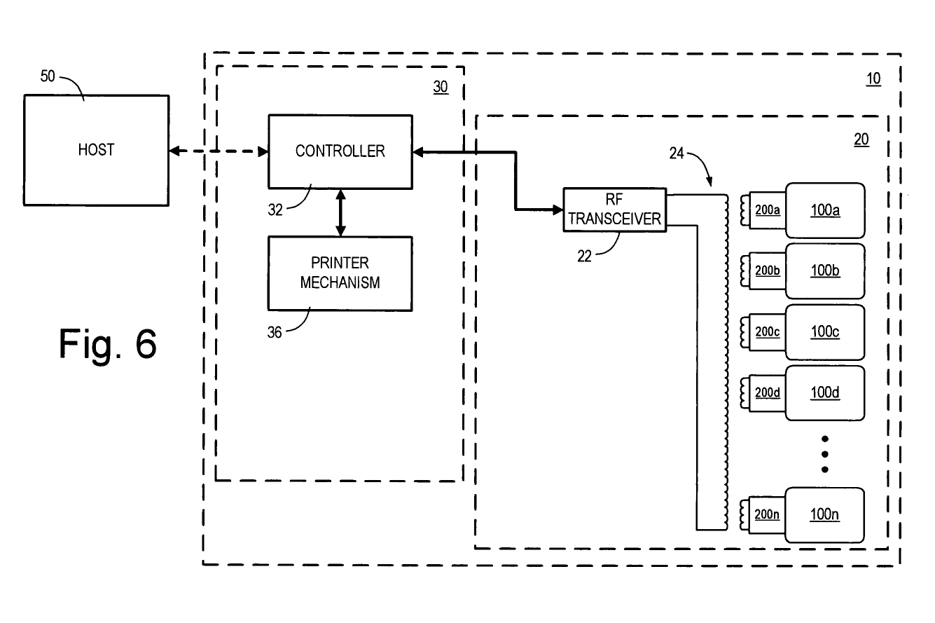

FIG. 6 illustrates an exemplary printing system 10 utilizing wireless memory devices 200a-200n on the replaceable printing components 100a-100n. Communication between the printing system and the wireless devices 200a-200n is controlled by a transceiver (writer/reader) 22. The function of the transceiver 22 is to convert an incoming digital serial data stream to a radio frequency carrier output that drives a transceiver coupling antenna 24. The RF energy from the transceiver antenna received by the wireless memory devices 200a-200n is used power the wireless memory devices. Commands are sent to the wireless memory devices by modulating the carrier frequency, as is known in the art. The wireless memory devices respond by sending modulated signals back to the transceiver by way of a changing load to the transceiver antenna. The transceiver detects the modulation induced by the wireless memory device load change and converts this to digital serial output data.

For some printing applications, where multiple ink cartridges are used, the single transceiver antenna must be of sufficient length to span all of the ink cartridges. In a system with six ink cartridges, for example, the antenna may need to span 25 cm or more. An antenna of this size requires a high power transceiver so that each ink cartridge receives enough RF energy to power itself. Further, it requires a very sensitive transceiver to enable the received signal from the wireless memory devices to be detected and appropriately quantized from the transceiver antenna.

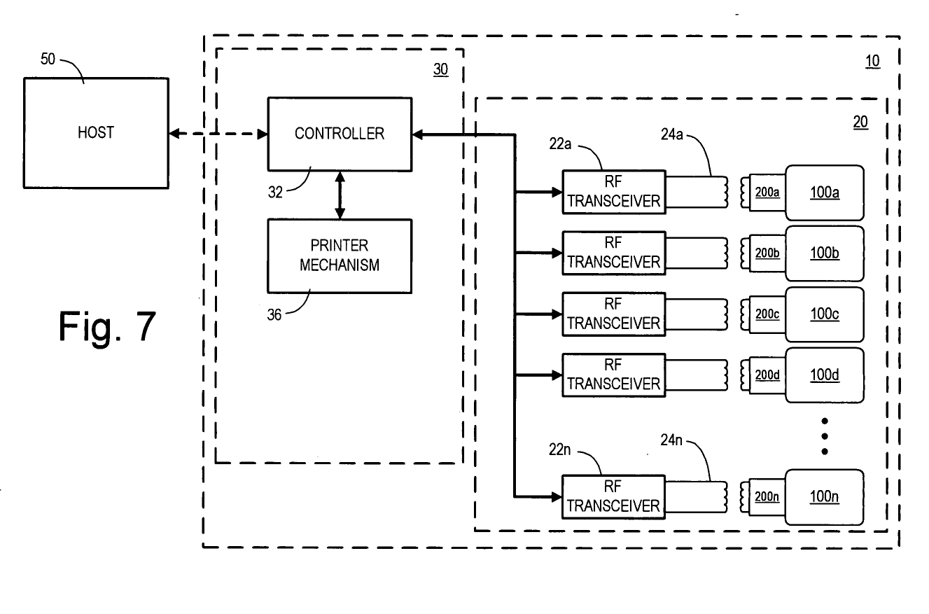

FIG. 7 illustrates an alternative printing system utilizing wireless memory devices. To reduce the power requirement and simplify the transceiver of the system, multiple transceivers 22a-22n and multiple antennas 24a-24n are used, one for each ink cartridge. This approach may be most appropriate where wireless memory devices are retrofitted into designs previously employing wired devices.

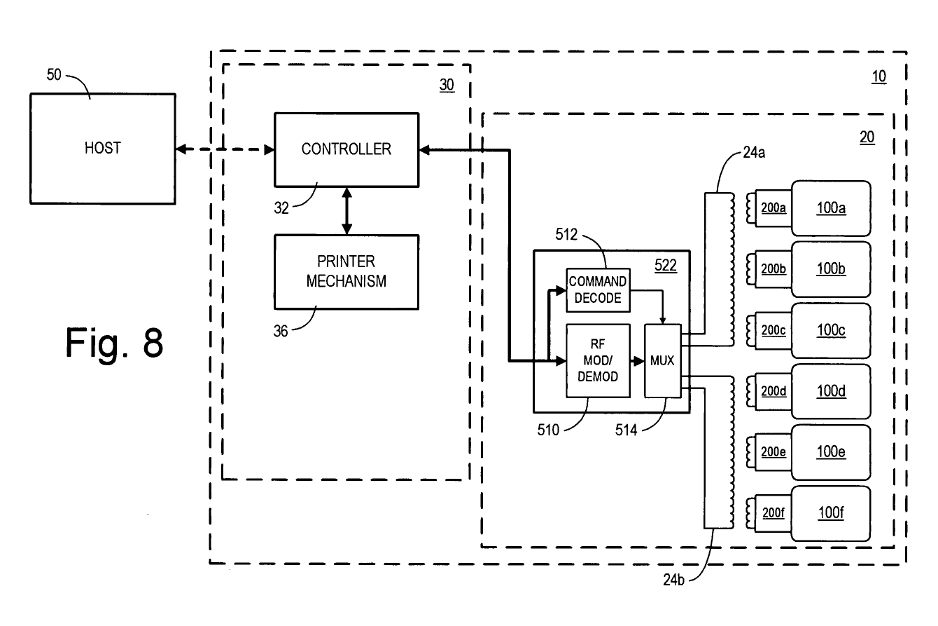

FIG. 8 illustrates a printing system according to an embodiment of the invention. For communicating with spatially dispersed wireless memory devices 200a-200f, the transceiver 522 is configured to support multiple separate antennas. The transceiver 522 may electronically select and address each antenna as needed, utilizing multiplexing techniques known in the art. In one embodiment, the transceiver may be an application specific integrated circuit (ASIC) including command decode logic 512 to decode commands from the controller 32; RF modulation/demodulation circuitry 510, and a multiplexer 514 to select one antenna for receive/transmit based upon a decoded command. Other selection techniques may also be employed, such as providing separate multiplexing control signals (not illustrated) from the controller.

Although FIG. 8 illustrates the replaceable printing components 100a-100f as ink containers placed side-by-side in a receiving station, the system of FIG. 8 is also applicable to systems where the components are located in different physical areas of the printer, such as, for example, one or more antennas may be placed in an off-axis ink container docking area, and one or more separate antennas may be placed adjacent to the user-replaceable printheads.

An advantage of using multiple antennas controlled from a single transceiver IC is a reduction in the required RF transmit power (the RF power required is reduced by a factor of approximately “M”, where M equals the number of transceiver antenna). Further, the required RF sensitivity of the transceiver receiver is also reduced by a factor of approximately M.

The cost of utilizing multiple antennas with a single transceiver may also result in lower overall system costs. The added cost of a transceiver with multiple antenna (over the cost of single transceiver antenna) is the cost of additional logic to capture the address commands, the cost of receiving RF modulation from multiple antenna, and the cost of additional Input/Output pins on the transceiver package. These costs are likely to be less than a complete transceiver package for each remote wireless memory device, and will be a less demanding design than a large single antenna spanning all the wireless memory devices in the system. The multiple antennas also result in less “stray” RF energy, simplifying compliance with emissions regulations.

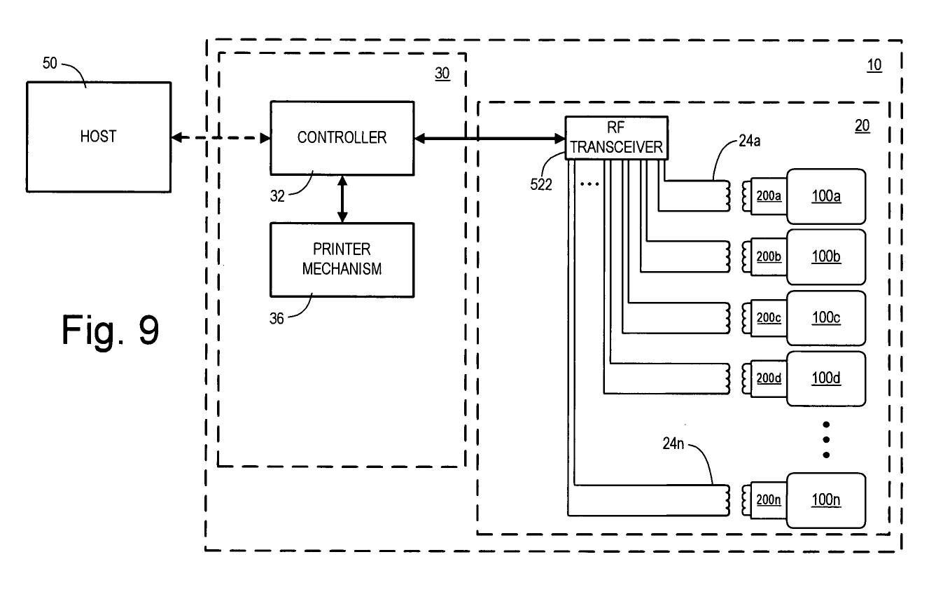

FIG. 9 depicts a generalized embodiment of the invention, illustrating a single RF transceiver 522 with an independent antenna 24a-24n for each wireless memory device 200a-200n in the system. For the exemplary integrated wireless memory devices described with respect to FIG. 3, above, this configuration allows the relatively short transmit/receive distances to be met with a relatively low power transceiver. The low power signals have an advantage of reducing potential crosstalk effects between devices, or with other components of the printer. Since a particular wireless device may be accessed by selectively activating the appropriate antenna, the need for each memory device to possess a unique address (such as would be required with system configurations shown in FIGS. 5, 6, and 8) would be obviated.

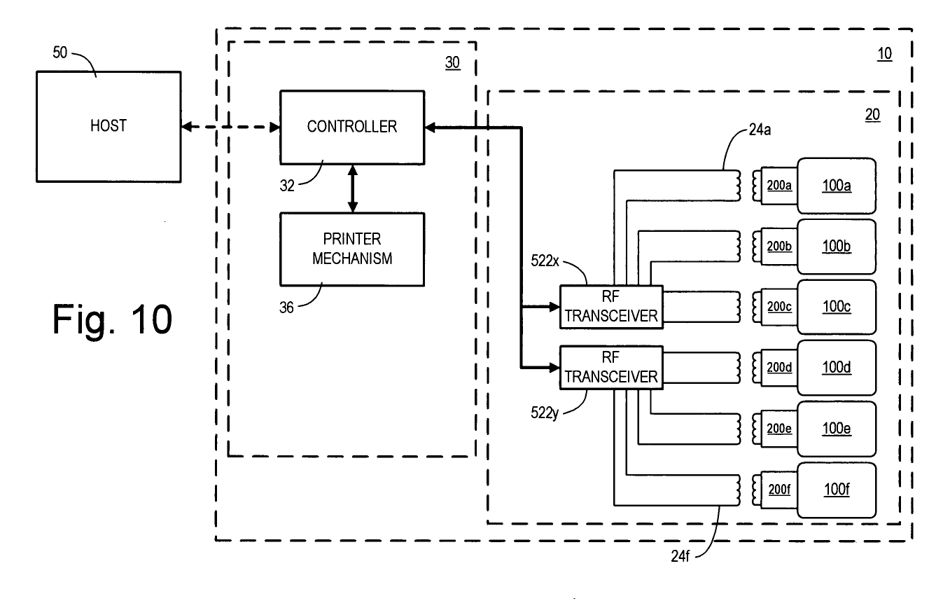

FIG. 10 depicts a further generalized embodiment of the invention, in which multiple transceivers 522x, 522y are utilized, with each transceiver adapted to control a plurality of antennas 24a-24f. Such a configuration may be desirable in situations where the replaceable printing components 100a-100f are not all co-located (such as with on-axis replaceable printheads and off-axis ink containers), or when other design considerations make a modular implementation attractive.

It is further noted that the replaceable printing components need not be permanently located near a transmit/receive antenna. The components may alternatively be brought into proximately of an antenna for the purposes of reading or writing, such as, for example, components with memory devices mounted on a scanning carriage of a printer might be brought into temporary proximity to an antenna mounted to a stationary portion of the printer. A single relatively small antenna might thus provide serially access multiple memory devices, as the devices are individually positioned adjacent to the antenna.

Embodiments of the invention further include methods of selectively activating one of a plurality of antennas in a printing system for communicating with wireless memory devices in replaceable printing components, the plurality of antennas electrically connected to a common transceiver. Embodiments of the method may further include generating a command in the control electronics of the printing system which specifies the antenna to be activated; sending the command to the transceiver; decoding the command in the transceiver; and selectively activating the specified antenna.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

The corresponding structures, materials, acts, and equivalents of all means or step plus function elements in the claims below are intended to include any structure, material, or acts for performing the functions in combination with other claimed elements as specifically claimed.

What is claimed is:

1. A transceiver for communicating with wireless memory devices in a printing system, the wireless memory devices integral with user-replaceable printing components, the printing system having a plurality of antennas for communicating with the wireless memory devices, the transceiver comprising:
radio frequency (RF) modulation and demodulation circuitry; and
a multiplexer for selectively connecting the RF modulation and demodulation circuitry to one of the plurality of antennas.

2. The transceiver for communicating with wireless memory devices in a printing system of claim 1, further comprising:
command decode logic for receiving commands from a controller and generating at least one control signal for the multiplexer.

3. The transceiver for communicating with wireless memory devices in a printing system of claim 1, wherein the transceiver comprises an application-specific integrated circuit (ASIC).

4. A transceiver for communicating with wireless memory devices in a printing system, the wireless memory devices integral with user-replaceable printing components, the printing system having a plurality of antennas for communicating with the wireless memory devices, the transceiver comprising:
radio frequency modulation and demodulation means;
multiplexing means for selectively connecting the radio frequency modulation and demodulation means to a plurality of antennas; and
multiplexer control means.

5. A printing system configured to accept multiple user-replaceable printing components, the user-replaceable printing components having integral wireless memory devices, the printing system comprising:
control electronics;
a plurality of antennas positioned for communication with the integral wireless memory devices of the multiple user-replaceable printing components;
a transceiver for communicating with the multiple wireless memory devices, the transceiver electrically connected to the control electronics, the transceiver comprising:
radio frequency (RF) modulation and demodulation circuitry; and
a multiplexer for selectively connecting the RF modulation and demodulation circuitry to one of the plurality of antennas.

6. The printing system configured to accept multiple user-replaceable printing components of claim 5, wherein the transceiver further comprises command decode logic for receiving commands from a controller and generating at least one control signal for the multiplexer.

7. The printing system configured to accept multiple user-replaceable printing components of claim 5, wherein the transceiver is an Application-Specific Integrated Circuit (ASIC).

8. The printing system configured to accept multiple user-replaceable printing components of claim 5, wherein the printing system is an inkjet printer.

9. The printing system configured to accept multiple user-replaceable printing components of claim 8, wherein the user-replaceable printing components comprise ink containers.

10. The printing system configured to accept multiple user-replaceable printing components of claim 9, wherein the inkjet printer further comprises a scanning carriage, and wherein the ink containers are removably attached to the scanning carriage.

11. The printing system configured to accept multiple user-replaceable printing components of claim 9, wherein the inkjet printer further comprises a stationary portion and a consumable receiving station located on the stationary portion, and wherein the ink containers are removably attached to the receiving station.

12. The printing system configured to accept multiple user-replaceable printing components of claim 8, wherein the user-replaceable printing components comprise printheads.

13. The printing system configured to accept multiple user-replaceable printing components of claim 5, wherein the printing system is an electrophotographic printer, and wherein the user-replaceable printing components comprise toner cartridges.

14. A printing system configured to accept multiple user-replaceable printing components, the user-replaceable printing components having integral wireless memory devices, the printing system comprising:
control means;
a plurality of antennas positioned for communication with the integral wireless memory devices of the multiple user-replaceable printing components;
transceiver means for communicating with the multiple wireless memory devices, the transceiver means electrically connected to the control electronics, the transceiver means comprising:
radio frequency (RF) modulation and demodulation circuitry; and
a multiplexer for selectively connecting the RF modulation and demodulation circuitry to one of the plurality of antennas.

15. A printing system configured to accept multiple user-replaceable printing components, the user-replaceable printing components having integral wireless memory devices, the printing system comprising:
control electronics;
a plurality of antennas positioned for communication with the integral wireless memory devices of the multiple user-replaceable printing components;
more than one transceiver for communicating with the multiple wireless memory devices, the more than one transceivers electrically connected to the control electronics, the more than one transceivers comprising:
radio frequency (RF) modulation and demodulation circuitry; and
a multiplexer for selectively connecting the RF modulation and demodulation circuitry to one of the plurality of antennas.

16. The printing system configured to accept multiple user-replaceable printing components of claim 15, wherein the transceiver further comprises command decode logic for receiving commands from a controller and generating at least one control signal for the multiplexer.

17. The printing system configured to accept multiple user-replaceable printing components of claim 15, wherein the transceiver is an Application-Specific Integrated Circuit (ASIC).

18. The printing system configured to accept multiple user-replaceable printing components of claim 15, wherein the printing system is an inkjet printer.

19. The printing system configured to accept multiple user-replaceable printing components of claim 18, wherein the user-replaceable printing components comprise ink containers.

20. The printing system configured to accept multiple user-replaceable printing components of claim 19, wherein the inkjet printer further comprises a scanning carriage, and wherein the ink containers are removably attached to the scanning carriage.

21. The printing system configured to accept multiple user-replaceable printing components of claim 19, wherein the inkjet printer further comprises a stationary portion and a consumable receiving station located on the stationary portion, and wherein the ink containers are removably attached to the receiving station.

22. The printing system configured to accept multiple user-replaceable printing components of claim 18, wherein the user-replaceable printing components comprise printheads.

23. The printing system configured to accept multiple user-replaceable printing components of claim 15, wherein the printing system is an electrophotographic printer, and wherein the user-replaceable printing components comprise toner cartridges.

24. A printing system configured to accept multiple user-replaceable printing components, the user-replaceable printing components having integral wireless memory devices, the printing system comprising:
control means;
a plurality of antennas positioned for communication with the integral wireless memory devices of the multiple user-replaceable printing components;
more than one transceiver means for communicating with the multiple wireless memory devices, the more than one transceiver means electrically connected to the control electronics, the more than one transceiver means comprising:
radio frequency (RF) modulation and demodulation circuitry; and
a multiplexer for selectively connecting the RF modulation and demodulation circuitry to one of the plurality of antennas.

25. A method of communicating with wireless memory devices integral with multiple user-replaceable printing components in a printing system, the printing system having control electronics in electrical communication with a transceiver, the transceiver connected to a plurality of antennas, the method comprising:
selectively activating an antenna in close proximity to one of the multiple user-replaceable printing components; and
electrically communicating with the integral memory device of the one of the multiple user-replaceable printing components.

26. The method of communicating with wireless memory devices integral with multiple user-replaceable printing components in a printing system of claim 25, wherein selectively activating an antenna further comprises generating a command within the control electronics and decoding the command within the transceiver.

27. The method of communicating with wireless memory devices integral with multiple user-replaceable printing components in a printing system of claim 25, wherein the printing system is an inkjet printer.

28. The method of communicating with wireless memory devices integral with multiple user-replaceable printing components in a printing system of claim 27, wherein the multiple user-replaceable printing components comprise ink containers.

29. The method of communicating with wireless memory devices integral with multiple user-replaceable printing components in a printing system of claim 27, wherein the multiple user-replaceable printing components comprise printheads.

30. The method of communicating with wireless memory devices integral with multiple user-replaceable printing components in a printing system of claim 25, wherein the printing system is an electrophotographic printer, and wherein the user-replaceable printing components comprise toner cartridges.
